(19) United States
(12) Patent Application Publication
(10) Pub. No.: US 2026/0008251 A1
(43) Pub. Date: Jan. 8, 2026

(54) A SOLID CELLULOSE FOAM OBJECT FORMED BY ASSEMBLY OF AT LEAST TWO SOLID CELLULOSE FOAM PORTIONS

(71) Applicant: Stora Enso OYJ, Helsinki (FI)

(72) Inventors: Daniel Hult Torron, Täby (SE); Oruc Köklükaya, Lidingö (SE); Martin Sterner, Farsta (SE)

(73) Assignee: Stora Enso OYJ, Helsinki (FI)

(21) Appl. No.: 19/112,327

(22) PCT Filed: Sep. 22, 2023
(86) PCT No.: PCT/IB2023/059383

§ 371 Date: Mar. 17, 2025

(30) Foreign Application Priority Data
Sep. 23, 2022 (SE) 2230309-3
Feb. 16, 2023 (SE) 2330087-4

(51) Int. Cl. B32B 5/32; B32B 1/00; B32B 5/18; B32B 7/12; B32B 23/04; B32B 37/12

(52) U.S. Cl. CPC B32B 5/32; B32B 1/00; B32B 5/18; B32B 7/12; B32B 23/04; B32B 37/12; B32B 2250/02; B32B 2250/22; B32B 2266/02; B32B 2307/546; B32B 2307/72

(57) ABSTRACT

The present invention relates to a solid cellulose foam object comprising a first solid cellulose foam portion attached to a second solid cellulose foam portion. optionally at least one additional solid cellulose foam portion may be attached to the first and/or the second solid cellulose foam portion. The invention also relates to a method for producing said solid cellulose foam object.

### FIELD OF THE INVENTION

The present invention relates to a solid cellulose foam object formed by assembly of at least two solid cellulose foam portions and a method of producing such a solid cellulose foam object. The solid cellulose foam object of the present invention may be used as a cushioning material in packaging.

### BACKGROUND

Different porous materials, such as foams, are commonly used in applications such as insulation in buildings and vehicles and as packaging materials that are used to protect various goods during storage and transportation.

Depending on the item to be protected, different types of protective packaging materials can be used. For many items, a low-weight cushioning material that reduces impact shock and vibrations is used. Common examples of such cushioning materials are petroleum-based polymer foams such as polyurethane, polyethylene and expanded polystyrene. The foams used should be low-weight, stable and easy to manufacture.

Today, there is an increasing interest in replacing petroleum-based polymers with polymers from renewable resources, i.e. biobased polymers. Cellulose is the most abundant renewable natural polymer on earth and is therefore of special interest. For a cellulose foam, recycling of the material in regular recycling streams may be possible, depending on the composition of the foam.

There are several examples of cellulose foams, prepared using different methods. Drying the wet foam composition is often a critical step. Since the stability of the wet foam is typically low, moulds are commonly used to prevent the foam from collapsing during drying. WO20200011587 A1 describes a porous material that is prepared by aerating a paste comprising cellulose fibres and gluten and depositing the aerated paste in a mould where it is dried. The dried porous material has the shape of the mould. WO2015036659 A1 describes a moulded fibrous product prepared by foaming an aqueous suspension of natural fibres in combination with synthetic fibres and surfactant, feeding the fibrous foam to a mould and drying the foam by first mechanically withdrawing a part of the water followed by evaporating water to produce a dry fibrous product.

When drying a cellulose foam object without restrictions, the cellulose foam will shrink in all directions, due to collapse of the foam, as tension forces pull the cellulose fibres together. Drying shrinkage is an inherent property of cellulose, as swollen cellulose fibres will collapse onto each other when water is removed from the system. Even in more complicated drying systems such as combined air impingement and IR-dryers, a shrinkage in the thickness direction of above 10% is expected. This is because of the capillary pressure build-up inside the material as the water level recedes during drying, leading to menisci forming between particles and as a result attractive inter particle forces. Increasing the dry component of foam having less affinity to water and/or hydrophobic character reduces the attractive forces occurring due to capillary pressure between particles. However, the network strength forming during drying is reduced due to reduction in the fiber-fiber joint strength as well as the number average of fiber-fiber joint.

To avoid or reduce shrinkage during drying, the cellulose foam object needs to dry under tension, such as in a frame or mould. The use of such restriction means will to a great extent prevent shrinkage of the foam in the width and length directions. When drying an object with a large surface area the tension obtained by the mould is however limited to the regions closest to the mould. Typically, the thickness of the foam will be reduced due to shrinkage in the middle of the object, with a gradual increase in thickness towards the edges. Thus, shrinkage during drying is a problem, especially when drying foam objects with large surface areas since the shrinkage is non-uniform and the thickness of the dried foam may vary along the width and length of the dry foam.

The drying time of a cellulose foam is typically long since both wet cellulose foams and dry cellulose foams are heat insulating. A short drying time is desired to enable a cost-efficient process.

Thus, there is still a need for alternative methods for the preparation of a cellulose foam. In addition, the prepared foam should have a high impact resistance when used as a packaging material to enable protection also of heavier portions.

### SUMMARY OF THE INVENTION

It is an object of the present invention to provide a solid cellulose foam, which is recyclable and made from renewable sources, and which eliminates or alleviates at least some of the disadvantages of the prior art materials.

It is a further object of the present invention to provide a dimensionally stable solid cellulose foam.

It is a further object of the present invention to provide an improved method of obtaining a solid cellulose foam with uniform thickness and minimized non-uniform shrinkage during drying, also when producing large foam articles.

It is a further object of the present invention to provide a cost-efficient method of obtaining a solid cellulose foam where the drying time of the foam is reduced.

The above-mentioned objects, as well as other objects as will be realized by the skilled person in light of the present disclosure, are achieved by the various aspects of the present disclosure.

The present invention is defined in the independent claims. Further embodiments of the invention are defined in the dependent claims.

According to a first aspect, the present invention relates to a solid cellulose foam object comprising: a first solid cellulose foam portion comprising a first connecting surface and optionally a second connecting surface; and a second solid cellulose foam portion comprising a first connecting surface and optionally a second connecting surface; wherein the first connecting surface of the first solid cellulose foam portion and the first connecting surface of the second solid cellulose foam portion are attached to each other so as to form the solid cellulose foam object; wherein the solid cellulose foam object optionally comprises at least one additional solid cellulose foam portion comprising a first connecting surface and optionally a second connecting surface, and wherein the first connecting surface of the at least one additional solid cellulose foam portion is attached to the second connecting surface of the first solid cellulose foam portion and/or the second solid cellulose foam portion.

It has surprisingly been found that by assembly of at least two solid cellulose foam portions into a solid cellulose foam object, a dimensionally stable foam product with no thickness variations due to non-uniform shrinkage can be obtained. Since the solid cellulose foam object is prepared by assembly of smaller solid cellulose foam portions, drying of a large foam object is avoided. Each solid cellulose foam portion used to assemble the solid cellulose foam object is prepared in a shape such that non-uniform shrinkage in the thickness direction is avoided or minimized during drying. Such a shape may be one where the dimensions of height and width are similar. It has been found that such a shape will minimize non-uniform shrinkage during drying. The solid cellulose foam portions may also be prepared such that they have complimentary shapes that fit together such that after assembly a solid cellulose foam object with no internal voids is formed. Depending on the desired size of the solid cellulose object, two or more solid cellulose foam portions can be assembled. The present invention thus enables manufacturing of very large structures of cellulose foam. In addition, the attachment of the first connecting surfaces of the first and second solid cellulose foam portions provide for an additional internal interface within the solid cellulose foam object. This will improve the mechanical properties, such as compression strength, of the solid cellulose foam object, since the number of stiff interfaces is increased.

It was also surprisingly found that the total drying time was reduced by drying at least two smaller cellulose foam portions instead of one larger cellulose foam structure. Since both wet cellulose foam and dry cellulose foam are heat insulating, drying times of larger foam objects are typically long. When instead drying smaller foam portions individually, a higher surface area to thickness ratio is obtained which will reduce the drying time. The total drying time is further reduced since several smaller portions can be dried simultaneously. This is beneficial from a cost perspective, since less energy is needed for drying.

According to a second aspect, the present invention relates to a method for producing a solid cellulose foam object, the method comprising the steps of:
providing at least one wet cellulose foam;
shaping and drying the wet cellulose foam, so as to obtain a first solid cellulose foam portion; a second solid cellulose foam portion; and optionally at least one additional solid cellulose foam portion; wherein the first solid cellulose foam portion comprises a first connecting surface and optionally a second connecting surface; wherein the second solid cellulose foam portion comprises a first connecting surface and optionally a second connecting surface; and wherein the optional at least one additional solid cellulose foam portion comprises a first connecting surface and optionally a second connecting surface;
attaching the first connecting surface of the first solid cellulose foam portion and the first connecting surface of the second cellulose foam portion so as to obtain a solid cellulose foam object; and
optionally attaching the first connecting surface of the at least one additional cellulose foam portion to the second connecting surface of the first solid cellulose foam portion and/or the second solid cellulose foam portion.

By selection of suitable shapes of the wet cellulose foam portions in the shaping step, non-uniform shrinkage will be prevented and the resulting solid cellulose foam portions can be used for assembly into solid cellulose foam objects that are dimensionally stable with a uniform thickness.

The solid cellulose foam object according to the first aspect may be obtained by the method according to the second aspect.

According to a third aspect, the present invention relates to a use of the solid cellulose foam according to the first aspect as a packaging material, a building material, a thermal insulation material, an acoustic insulation material or as a hydroponic plant growth media.

The solid cellulose foam according to the first aspect has a high impact resistance and excellent cushioning properties, and can be used as a packaging material in various protective packaging applications. It can also be used as a building material, or as a thermal or acoustic insulation material. The solid cellulose foam may also be used as a hydroponic plant growth media. The solid cellulose foam object is made from renewable resources and can be re-dispersed in water and as a result be recyclable in regular paper recycling streams.

The cellulose foam of the present invention preferably comprises in the range of from 71 to 95 wt % cellulose fibres, as calculated on the total weight of solid content in the foam, in the range of from 4 to 24 wt % of a water-soluble thickener, as calculated on the total weight of solid content in the foam, and at least two surfactants.

### BRIEF DESCRIPTION OF THE DRAWINGS

The embodiments of the present invention are best understood by reference to the following description and the enclosed drawings. The invention will be described in more detail with reference to the enclosed drawings, in which:

FIG. 1a schematically illustrates an embodiment of a solid cellulose foam object assembled from a first and a second solid cellulose foam portion, the portions being of equal size.

FIG. 1b schematically illustrates an embodiment of a solid cellulose foam object assembled from a first, a second and one additional solid cellulose foam portion, the portions being of different size.

FIG. 1c schematically illustrates an embodiment of a solid cellulose foam object assembled from a first, a second and two additional solid cellulose foam portions, the portions being of equal size.

FIG. 1d schematically illustrates an embodiment of a solid cellulose foam object assembled from a total of 8 solid cellulose foam portions, the portions being of equal size.

FIG. 2 schematically illustrates an embodiment of a first, a second and two additional solid cellulose foam portions, that are assembled to a solid cellulose foam object. The solid cellulose foam portions are of equal size.

FIG. 3a schematically illustrates an embodiment of a first solid cellulose foam portion comprising four protruding portions in the form of pillars; and a second solid cellulose foam portion comprising four recesses with a shape corresponding to the pillars of the first solid cellulose foam portion.

FIG. 3b schematically illustrates a solid cellulose foam object formed by assembly of the portions shown in FIG. 3a.

FIG. 4a schematically illustrates an embodiment of a first solid cellulose foam portion and a second solid cellulose foam portion, both foam portions comprising a first connecting surface in turn comprising both protruding portions and recesses. The protruding portions and recesses extend along the entire length of the foam portions, and connecting surfaces have a waveform, in the form of a sine wave, in cross section.

FIG. 4b schematically illustrates a side view of a solid cellulose foam object formed by assembly of the portions shown in FIG. 4a.

FIG. 5a schematically illustrates an embodiment of a first solid cellulose foam portion comprising regularly placed pillars; and a second solid cellulose foam portion having a complementary shape to that of the first solid cellulose foam portion.

FIG. 5b schematically illustrates a solid cellulose foam object formed by assembly of the portions shown in FIG. 5a.

FIG. 6 shows drying curves obtained during drying of a wet cellulose foam deposited in one step and, in the reference shape of a foam sheet with flat surfaces (⋄), in the shape of a rod (▭), in the shape of a foam sheet with a top surface having the shape of a sine wave (○), or in the shape of a foam sheet with the bottom surface having the shape of a triangular wave (▴).

### DETAILED DESCRIPTION

The embodiments of the present invention refer to assembly of solid cellulose foam portions of various shapes into a solid cellulose foam object.

The term “foam”, as used herein, refers to a substance made by trapping air or gas bubbles inside a solid or liquid. Typically, the volume of gas is much larger than that of the liquid or solid, with thin films separating gas pockets. Three requirements must be met in order for foam to form. Mechanical work is needed to increase the surface area. This can occur by agitation, dispersing a large volume of gas into a liquid, or injecting a gas into a liquid. The second requirement is that a foam forming agent, typically an amphiphilic substance, a surfactant or surface-active component, must be present to decrease surface tension. Finally, the foam must form more quickly than it breaks down.

The term “cellulose foam”, as used herein, refers to a foam comprising cellulose, and other components such as thickeners, surfactants and additives. The main component of the cellulose foam is cellulose, such that cellulose constitutes at least 70 wt % of the dry content of the cellulose foam. Cellulose is in the form of fibres, and the foam can thus also be defined to be a fibrous foam or a cellulose fibre foam. The cellulose foam may be wet or solid.

The term “wet foam”, or “wet cellulose foam”, as used herein, refers to a wet foam comprising cellulose, and other components such as thickeners, surfactants and additives. Gas bubbles are present within the wet foam. The wet foam is freestanding and behaves as a viscoelastic solid. This means that the wet foam has both viscous and elastic properties. The wet foam will behave as a solid, and thus be freestanding, unless a large enough force is applied so that it starts to flow and instead behave as a viscous material. Depending on the magnitude and timescale of any applied shear stress, the wet foam can show a predominantly viscous or elastic behaviour.

The term “solid cellulose foam”, or “dry cellulose foam”, as used herein, refers to a dry porous cellulose material that has been formed from a wet cellulose foam, i.e. a foam formed material. During the drying process, a closed wet cellulose foam is transformed into an open solid cellulose foam. The network of cellulose fibres is prevented from collapsing during drying. The solid cellulose foam will as a result have a shape that to a large extent corresponds to that of the wet cellulose foam. The dry content of the solid cellulose foam is at least 95 wt % as calculated based on the total weight of the solid cellulose foam. The shape and density of the solid cellulose foam is retained also in a non-confined state. The solid cellulose foam has an open cell structure, allowing air to occupy the pores within the foam. The solid cellulose foam can also be described as a porous material or a low-density material.

The cellulose foam preferably used in the cellulose foam portions of the present invention will now be described in detail.

The cellulose foam used in the present invention preferably comprises cellulose fibres in a range from 71 to 95 wt %, such as from 75 to 95 wt %, based on the total dry weight of the cellulose foam.

Cellulose fibres suitable for use in the present invention can originate from wood, such as softwood or hardwood, from leaves or from fibre crops (including cotton, flax and hemp). The cellulose fibres suitable for use in the present invention can also originate from regenerated cellulose such as rayon and Lyocell. The cellulose fibres suitable for use in the present invention may include lignin or hemicellulose or both, or the cellulose fibres may be free from lignin and hemicellulose. Preferably, the cellulose fibres originate from wood, more preferably the cellulose fibres are pulp fibres obtained by pulping processes which liberates the fibres from the wood matrix. Pulp fibres can be liberated by mechanical pulping, obtaining mechanical pulp such as thermomechanical pulp (TMP) or chemical thermomechanical pulp (CTMP), or by chemical pulping such as Kraft pulp or pulps obtained by the sulphite process, soda process or organosolv pulping process. More preferably, the cellulose fibres are pulp fibres liberated by chemical pulping processes. The different characteristic of each cellulose fibre will affect the properties of the final cellulose foam. A cellulose fibre is significantly longer than it is wide. Cellulose fibres can have a mean width of 0.01 to 0.05 mm. The fibre length of softwood can be from 2.5 to 4.5 mm, while hardwood can have a fibre length from 0.7 to 1.6 mm, and Eucalyptus from 0.7 to 1.5 mm. However, the fibre length can vary considerably with different growing place etc. The cellulose fibres in the cellulose foam disclosed herein can have a length from 0.1 mm to 65 mm, or from 0.1 mm to 10 mm, or from 0.5 mm to 65 mm, or from 0.5 mm to 10 mm, or from 0.5 mm to 7 mm. The fibre lengths may provide different mechanical characteristics to the foam. Due to the length of fibres, they can entangle with each other and impart fibre to fibre interbonds that bring strength to the foam. The aspect ratio, i.e. the ratio of the fibre length to the fibre width, of the cellulose fibres in the cellulose foam according to the present invention can be at least 10, at least 25, at least 50, at least 75, or at least 100, which provides for preservation and stabilization of the foam structure during the drying procedure, making it possible to dry the wet cellulose foam with retained shape. The aspect ratio can be up to 6500, or preferably up to 2000.

The cellulose fibres may be modified to provide different properties to the final cellulose foam. For example, phosphorylated fibres or periodate oxidized fibres could also be used when producing a cellulose foam according to the present invention.

Preferably, the cellulose fibres are selected from wood pulp, such as softwood Kraft bleached pulp, hardwood pulp, chemical-thermomechanical pulp, and from dissolving pulp, or a combination of one or more of these. More preferably the cellulose pulp fibres are from softwood pulp, chemical-thermomechanical pulp, or dissolving pulp. Most preferably the cellulose pulp fibres are from softwood pulp, such as softwood Kraft bleached pulp.

The cellulose foam used in the present invention preferably comprises cellulose fibres in a range of from 71 to 95 wt %, such as from 75 to 95 wt %, based on the total dry weight of the cellulose foam, a water-soluble thickener in a range of from 4 to 24 wt %, such as from 5 to 20 wt %, based on the total dry weight of the cellulose foam, and at least two surfactants.

The cellulose foam used in the first, second and additional solid cellulose foam portions may have the same composition or different compositions.

The water-soluble thickener may have a molecular weight of from 80 000-250 000 g/mol, or from 83 000-197 000 g/mol. Exemplary water-soluble thickeners are selected from carboxy methyl cellulose (CMC), methyl cellulose (MC), hydroxyethyl cellulose (HEC), ethyl hydroxyethyl cellulose (EHEC), methyl hydroxypropyl cellulose (MHPC), starch, xanthan, guar gum, and xyloglucan, or mixtures thereof. The fact that the thickener is water-soluble facilitates recycling of the cellulose foam.

The water-soluble thickener may improve the fibre-fibre bonding strength, primarily through hydrogen bonding, in the cellulose foam. Therefore, the amount of water-soluble thickener will influence the mechanical performance of the cellulose foam, and especially the bulk of the material. A higher content of water-soluble thickener provides for a stiffer material. Thus, the water-soluble thickener enables tailoring of the mechanical properties.

The cellulose foam may also comprise a mixture of at least two surfactants. One of the at least two surfactants is preferably a fast-acting surfactant, a suitable surfactant for this purpose is an anionic surfactant, preferably a low-molecular weight anionic surfactant. The anionic surfactant may have an apparent pKa of from 3.2 to 3.8, preferably from 3.4 to 3.6, or an apparent pKa of 3.5 in a solution having a pH of from 7 to 9, preferably a pH of 8. The low-molecular weight anionic surfactant may be selected from sodium dodecyl sulphate (SDS); potassium dodecyl sulphate, sodium laureth sulphate (SLES); sodium dodecylbenzenesulphonate; sodium cocoyl sarcosinate; sodium lauroyl sarcosinate. The low-molecular weight anionic surfactant is preferably selected from sodium dodecyl sulphate (SDS); sodium p-n-dodecylbenzenesulphonate; sodium cocoyl sarcosinate; and sodium lauroyl sarcosinate. More preferably the low-molecular weight anionic surfactant is sodium cocoyl sarcosinate. The anionic surfactant may be biodegradable.

The other one of the at least two surfactants is preferably a co-surfactant. The co-surfactant may be selected from the group comprising surfactants having an apparent pKa of at least 8, or at least 9, in a surfactant solution having pH of from 7to 9, preferably having a pH of 8; and amphoteric betaines. The co-surfactant may have maximum apparent pKa of 10. The co-surfactant preferably has a long carbon chain, more preferably a carbon chain with 14 carbon atoms (C14). The co-surfactant may be selected from high pKa fatty acids, such as from plant derived feedstock, e.g. tetradecanoic acid (myristic acid), sodium oleate, lauric acid, palmitic acid, and stearic acid; glucose based co-surfactants with an aliphatic carbon tail, such as alkyl glycosides, alkylpolyglucosides, alkyl thio-glycosides, and alkyl maltosides; amphoteric betaines, such as cocamidopropyl betaine (CAPB), and sodium cocoiminodipropionate (CADP); polyethylene glycol sorbitan monolaurate, i.e. tween® (e.g. tween®) 20, tween® 80 and tween® 85); and polyoxyethylene lauryl ethers, such as polyethylene glycol dodecyl ether, pentaethylene glycol monododecyl ether and octaethylene glycol monododecyl ether.

Thus, the at least two surfactants used in the cellulose foam preferably comprise a mixture of an anionic surfactant and a co-surfactant. The molar ratio between anionic surfactant to co-surfactant may be from 0.2:1 to 3:1, preferably from 0.5:1 to 2:1. The total amount of the at least two surfactants together in the cellulose foam may be 0.6-5 wt %, or 0.8-2.0 wt %, as calculated on the total weight of the cellulose foam.

The solid cellulose foam can be re-dispersed in water and as a result be recyclable in regular paper recycling streams.

The wet cellulose foam may be prepared using a method comprising the following steps:
disintegrating cellulose fibres in water to obtain a slurry of cellulose fibres;
adding a water-soluble thickener to the slurry to obtain a mixture of thickener and cellulose fibres in water;
adding at least two surfactants to the mixture to obtain a fibre suspension; and
aerating the fibre suspension to obtain a wet foam, wherein the wet cellulose foam comprises 10-38 wt % cellulose fibres, 0.5-10 wt % of the water-soluble thickener, and 0.1-2 wt % surfactants, as calculated on the total weight of the wet foam, and wherein the wet cellulose foam has a density of from 120-500 kg/m³, or from 120-400 kg/m³, and a yield stress of at least 80 Pa.

In some embodiments, the yield stress of the wet cellulose foam may be at least 80Pa, or at least 100 Pa, or at least 150 Pa, or from 80 to 500 Pa, or from 100 to 500 Pa, or from 150 to 500 Pa.

Addition of a water-soluble thickener increases the viscosity of the slurry and enables incorporation of enough air to generate a densely packed foam during aeration. Since the cellulose fibres are mixed in high concentrations a drainage step is not needed, which enables the use of a water-soluble bio-based thickener in high concentrations.

Addition of a fast-acting surfactant will contribute to the formation of a cellulose foam with a high density and a high viscosity as it will quickly settle at the air-water interphase during aeration. This enables a free-standing wet cellulose foam. Addition of a co-surfactant along with the fast-acting surfactant will further improve the properties of the cellulose foam since it will facilitate the action of the fast-acting surfactant. A co-surfactant having a suitable pKa and a long carbon chain further contributes to a stable fibre suspension and a stable wet cellulose foam.

Upon aeration the composition comprising cellulose fibres, thickener and at least two surfactants will form a highly stable wet fibre foam. The aeration may be performed by mechanical agitation, and a substantial amount of air is incorporated into the material. The formation of a foam will be promoted by the surfactants. By adjusting the stability of the wet foam with the use of thickeners and surfactant combinations, a free-standing cellulose foam can be made without the use of a cross-linker or fibrillated cellulose. A good stability of the foam prevents ripening, i.e. change in bubble size, and drainage. The obtained wet foam is free-standing and does not require a mould or a forming fabric to retain its shape upon drying. The wet foam can thus be formed into a free-standing foam that is stable enough to be dried in the absence of a supporting mould without collapsing. As a result, the cellulose foam portions of the present invention can be formed and dried without the use of a mould. Depending on the shape of the wet cellulose foam, the amount of shrinkage during drying can be minimized as further outlined in relation to the various embodiments of the present invention. If a dry foam with a specific shape is desired, it may be beneficial to dry to wet foam with the use of a mould to improve the precision.

In some embodiments, the yield stress of the wet cellulose foams used in the present invention may be at least 80 Pa, or at least 100 Pa, or at least 150 Pa, or from 80 to 500 Pa, or from 100 to 500 Pa, or from 150 to 500 Pa.

In some embodiments, the density of the wet cellulose foams used in the present invention may be from 70-600 kg/m³, or from 100-500 kg/m³, or from 100-400 kg/m³, or from 125-375 kg/m³, or from 140-375 kg/m³.

In some embodiments, the wet cellulose foam used in the present invention comprises at least 10 wt % cellulose, as calculated on the total weight of the wet cellulose foam. In some embodiments, the wet cellulose foam may comprise 10-40wt %, 11-40 wt %, 10-30 wt %, 11-30 wt %, 10-20 wt %, or 11-20 wt %, cellulose fibres, as calculated on the total weight of the wet cellulose foam.

The bubble size in the wet foam is typically below 100 μm. This provides for a homogenous wet foam with good stability that does not flocculate during processing. During processing, and also during the subsequent drying step, the average bubble size is maintained to a large extent and the cellulose fibres remain well dispersed. The resulting solid cellulose foam obtained by drying the wet foam will be homogenous in structure, strong, have good mechanical properties, a smooth surface and no defects. A smooth surface is beneficial when a substrate is to be attached to the foam, since it facilitates adhesion.

In comparison, a wet cellulose foam with low stability has a larger average bubble size (i.e. typically above 100 μm) and the bubbles will coalesce faster during processing and drying such that larger bubbles are formed. In addition, the cellulose fibres will form clusters during processing and drying. This results in the wet foam collapsing during drying. The resulting solid cellulose foam will not have a homogenous structure and will also contain defects in the form of cavities resulting from the coalesced bubbles in the wet foam. Such a solid cellulose foam is, due to the defects, weak and has a rough surface.

Because of the high solid content, the wet foam does not need to be dewatered before it is dried. The foam may be dried by evaporation at room temperature or at an elevated temperature, such as a temperature of from 40° C. to 140° C. After drying, the solid cellulose foam may have a density of from 10 to 80 kg/m³, or from 10 to 60 kg/m³ or from 20 to 50 kg/m³. The solid cellulose foam may after drying have a solid content in the range of from 95 to 100 wt %, preferably from 98 to 100 wt %, as calculated on the total weight of the solid cellulose foam.

In preferred embodiments the cellulose foam comprises cellulose fibres in a range of from 71 to 95 wt %, such as from 75 to 95 wt %, based on the total dry weight of the cellulose foam, a water-soluble thickener in a range of from 4 to 24 wt %, such as from 5 to 20 wt %, based on the total dry weight of the cellulose foam, and at least two surfactants. A wet cellulose foam having such a composition is homogenous in structure and has a good stability as discussed above. Such a wet cellulose foam can also be dried without prior dewatering.

The solid cellulose foam of the present invention is essentially rigid. The term “essentially rigid” as used herein refers to a foam material that is stiff, non-elastic and that cannot be bent or flexed without causing permanent damage to the material. When compressed, the structure of the cellulose foam is damaged and the shape of the cellulose foam will be permanently altered.

During drying a densified layer is formed on the outer surface of the wet cellulose foam and remains on the outer surface of the dried cellulose foam. The densified layer comprises cellulose fibres that are packed more tightly and partly oriented differently compared to the bulk. The densified layers have improved mechanical stability and strength as compared to the core of the cellulose foam. The core of the cellulose foam comprises a homogenous open-cell fibre network. The core is highly porous, and even though the densified layer has a denser structure than the core, it is still porous. The densified layer provides the cellulose foam with increased stability and mechanical strength. The thin thickness of the densified layer implies that it practically does not affect the overall density of the cellulose foam.

The cellulose foam described above is the preferred foam to use in the solid cellulose foam portions in the present invention. Alternatively, other cellulose foams, such as those disclosed in WO2016068771 A1, WO2016068787 A1, and WO2020011587 A1 may be used.

The first aspect of the present invention, a solid cellulose foam object formed by assembly of at least a first solid cellulose foam portion and a second solid cellulose foam portion, is now to be described in more detail with reference to the figures.

The first aspect relates to a solid cellulose foam object 100, 200, 300, 400, 500, 600, 700, 800 comprising: a first solid cellulose foam portion 110, 210, 310, 410, 510, 610, 710, 810 comprising a first connecting surface 511, 611, 711, 811 and optionally a second connecting surface 512; and a second solid cellulose foam portion 120, 220, 320, 420, 520, 620, 720, 820 comprising a first connecting surface 521, 621, 721, 821 and optionally a second connecting surface 522; wherein the first connecting surface 511, 611, 711, 811 of the first solid cellulose foam portion 110, 210, 310, 410, 510, 610, 710, 810 and the first connecting surface 521, 621, 721, 821 of the second solid cellulose foam portion 120, 220, 320, 420, 520, 620, 720, 820 are attached to each other so as to form the solid cellulose foam object 100, 200, 300, 400, 500, 600, 700, 800; wherein the solid cellulose foam object 100, 200, 300, 400, 500, 600, 700, 800 optionally comprises at least one additional solid cellulose foam portion 230, 330, 430, 530 comprising a first connecting surface 531 and optionally a second connecting surface 532, and wherein the first connecting surface 531 of the at least one additional solid cellulose foam portion 230, 330, 430, 530 is attached to the second connecting surface 512, 612, 712, 812, 522, 622, 722, 822 of the first solid cellulose foam portion 110, 210, 310, 410, 510, 610, 710, 810 and/or the second solid cellulose foam portion 220, 320, 420, 520.

The term “solid cellulose foam object” as used herein refers to a foam product of any shape such as a block, a cube, a plank, a cylinder or any irregular shape. Preferably, the solid cellulose foam object 100, 200, 300, 400, 500, 600, 700, 800 is in the shape of a cuboid. The solid cellulose foam object 100, 200, 300, 400, 500, 600, 700, 800 is assembled from at least two individual solid cellulose foam portions, which are distinguishable from each other also after assembly. After assembly, the solid cellulose foam object 100, 200, 300, 400, 500, 600, 700, 800 resembles an object formed from one piece of material and there are no internal voids within the solid cellulose foam object 100, 200, 300, 400, 500, 600, 700, 800. The individual solid cellulose foam portions fit together such that no gaps or voids are formed during assembly. The solid cellulose foam portions are attached to each other such that they can not easily be removed, i.e. they are permanently attached. The solid cellulose foam object 100, 200, 300, 400, 500, 600, 700, 800 is dimensionally stable. The term “dimensionally stable” as used herein refers to an object that has no, or minimal, undesired variations in its dimensions. For example, the thickness may be uniform along the direction of the width and/or length of the object 100, 200, 300, 400, 500, 600, 700, 800.

The solid cellulose foam object 100, 200, 300, 400, 500, 600, 700, 800 is preferably essentially rigid. The solid cellulose foam portions used to assemble the solid cellulose foam object 100, 200, 300, 400, 500, 600, 700, 800 are also preferably essentially rigid.

The solid cellulose foam object 100, 200, 300, 400, 500, 600, 700, 800 may have a density of from 10 to 80 kg/m³, or from 10 to 60 kg/m³ or from 20 to 50 kg/m³. The solid cellulose foam object 100, 200, 300, 400, 500, 600, 700, 800 may have a solid content in the range of from 95 to 100 wt %, preferably from 98 to 100 wt %, as calculated on the total weight of the solid cellulose foam. The density of each solid cellulose foam portion used to assemble the solid cellulose foam object 100, 200, 300, 400, 500, 600, 700, 800 may be from 10 to 80 kg/m³, or from 10 to 60 kg/m³ or from 20 to 50 kg/m³. The solid content of each solid cellulose foam portion used to assemble the solid cellulose foam object 100, 200, 300, 400, 500, 600, 700, 800 may be in the range of from 95 to 100 wt %, preferably from 98 to 100 wt %, as calculated on the total weight of the solid cellulose foam.

In all embodiments of the present invention, the composition of the cellulose foam in the individual solid cellulose foam portions may be identical or different. Other properties, such as density, size and shape of the at least two individual pieces may also be identical or different. By selecting solid cellulose foam portions having specified shapes and properties, a versatile foam material with tailormade properties, such as rigidity and impact-resistance, depending on the intended application, may be provided.

The term “connecting surface” as used herein, refers to any surface of a solid cellulose foam portion that may be used to partly or fully attach the solid cellulose foam portion to another, adjacent solid cellulose foam portion. Any connecting surface of a solid cellulose foam portion may be attached to a connecting surface of another solid cellulose foam portion, or not. The connecting surfaces may be flat, or may comprise protruding portions and/or recesses.

The connecting surfaces may comprise a densified layer. A densified layer may improve the strength of the connecting surfaces and may thus facilitate the attachment to another connecting surface.

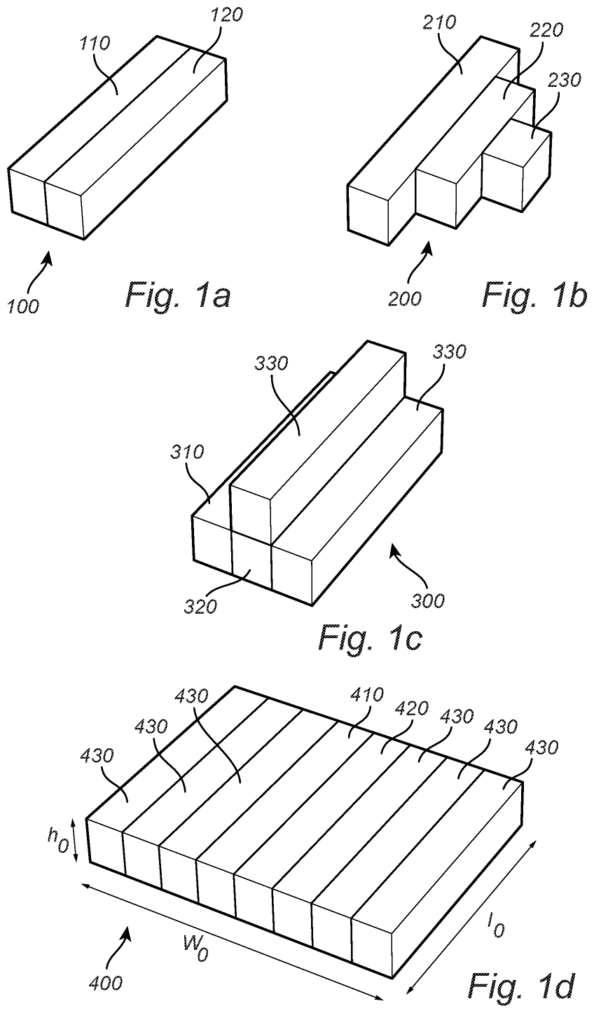

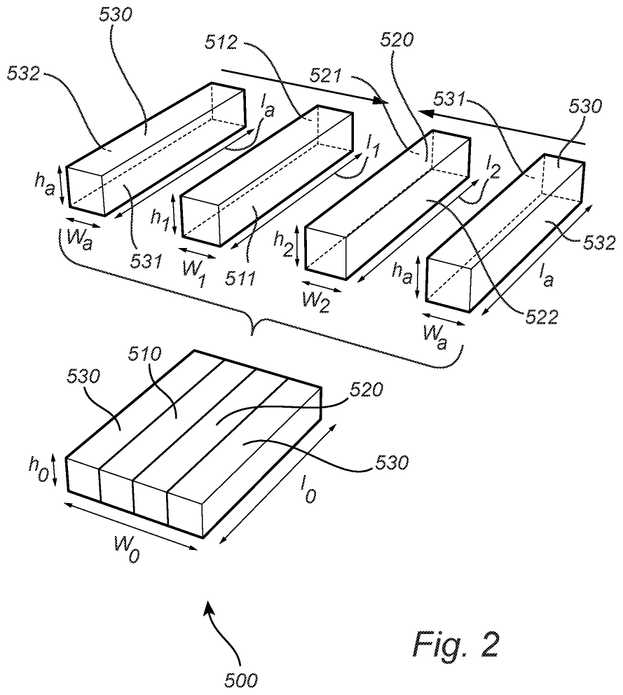

In one embodiment of the present invention, as illustrated in FIG. 1a, a solid cellulose foam object 100 is assembled by attaching a first solid cellulose foam portion 110 and a second solid cellulose foam portion 120. In other embodiments, as illustrated in FIG. 1b, FIG. 1c, FIG. 1d and FIG. 2, at least one additional solid cellulose foam portion 230, 330, 530 is assembled in addition to the first cellulose foam portion 210, 310, 510 and second solid cellulose foam portion 220, 320, 520.

In some embodiments, such as illustrated in FIG. 1a, where the solid cellulose foam object 100 is assembled from two solid cellulose foam portions 110, 120, only one connecting surface of each solid cellulose foam portion 110, 120 will be connected to the connecting surface of another solid cellulose foam portion 110, 120.

FIG. 2 shows an embodiment of the present invention where four solid cellulose foam portions 510, 520, 530 of equal size are assembled to a solid cellulose foam object 500. The solid cellulose foam object 500 has a cuboid shape and has a length lₒ, a height hₒ and a width wₒ. The solid cellulose foam object 500 comprises a first solid cellulose foam portion 510 comprising a first connecting surface 511 and a second connecting surface 512; a second cellulose foam portion 520 comprising a first connecting surface 521 and a second connecting surface 522; and two additional solid cellulose foam portions 530, each comprising a first connecting surface 531 and a second connecting surface 532. During assembly of the solid cellulose foam object, the first connecting surface 511 of the first solid cellulose foam portion 510 is attached to the first connecting surface 521 of the second solid cellulose foam portion 520. The first connecting surfaces 531 of the two additional solid cellulose foam portions 530 are attached to the second connecting surfaces 512, 522 of the first solid cellulose foam portion 510 and second solid cellulose foam portion 520 respectively.

The connecting surfaces 511, 512, 521, 522, 531, 532 of the embodiments in FIGS. 1 and 2 are all flat. A flat connecting surface facilitates assembly of solid foam portions of the same shape.

In the embodiment illustrated in FIG. 2, the first connecting surfaces 511, 521, 531 and second connecting surfaces 512, 522, 532 of a solid cellulose foam portion are on opposite sides of the solid cellulose foam portion. In other embodiments, such as illustrated in FIG. 1c, the connecting surfaces are on adjacent sides of the solid cellulose foam portion 320. In some embodiments, as also illustrated in FIG. 1c, a solid cellulose foam portion 320 may comprise additional connecting surfaces. The solid cellulose foam portion 320 of FIG. 1c comprises three connecting surfaces.

The four solid cellulose foam portions 510, 520, 530 in the embodiment illustrated in FIG. 2 are all of a cuboid shape. The first solid cellulose foam portion 510 has a length l₁, a width w₁ and a height h₁; the second solid cellulose foam portion 520 has a length l₂, a width w₂ and a height h₂, and the two additional solid cellulose foam portions 530 have a length la, a width wₐ and a height hₐ. The solid cellulose foam portions 510, 520 and 530 have the same length, the same width and the same height. The cuboid shape is preferable in applications where the solid cellulose foam object 500 is to have the shape of a plank. Depending on the shape of the solid cellulose foam object, it is often advantageous from a process perspective to produce solid cellulose foam portions that are identical to each other, both in terms of composition, size and shape. Large scale production is facilitated since there is no variation between the produced objects. In the embodiment illustrated in FIG. 2, attachment occurs over the entire surface area of the connecting surfaces 511, 512, 521, 522, 531, 532 of adjacent solid cellulose foam objects 510, 520, 530. The connecting surfaces 511, 512, 521, 522, 531, 532 of the first solid cellulose foam portion 510, the second solid cellulose foam portion 520 and the two additional cellulose foam portions 530 are all situated along the length of the solid cellulose foam portions 510, 520, 530, and are all flat. As easily realized by a person skilled in the art, any number of further additional solid cellulose foam portions 530 can be attached to the second connecting surfaces 532 of one or both of the additional solid cellulose foam portions 530 attached to the first or second solid cellulose foam portions 510, 520. In such embodiments, attachment occurs between connecting surfaces 531, 532 of adjacent additional solid cellulose foam portions 530.

In one embodiment, as illustrated in FIG. 1b, the sizes and shapes of the solid cellulose foam portions 210, 220 and 230 are different. This is advantageous if solid cellulose foam objects 200 of more complicated shapes are required, such as for a specific packaging application. In this embodiment, attachment occurs only in the overlapping surface areas of the connecting surfaces of adjacent solid cellulose foam portions 210, 220, 230.

In embodiments such as illustrated in FIG. 1a-d and 2, in order to minimize non-uniform shrinkage during drying, it is preferable that each solid cellulose foam portion 110, 120, 210, 220, 230, 310, 320, 330, 410, 420, 430, 510, 520, 530 has a width that is similar to the height. Preferably, the width of a solid cellulose foam portion 110, 120, 210, 220, 230, 310, 320, 330, 410, 420, 430, 510, 520, 530 is in the range of from 0.8 to 1.2, such as 0.9 to 1.1, or 0.95 to 1.05, times its height. The width and height of each solid cellulose foam portions 110, 120, 210, 220, 230, 310, 320, 330, 410, 420, 430, 510, 520, 530 may also be equal. The length of each solid cellulose foam portion 110, 120, 210, 220, 230, 310, 320, 330, 410, 420, 430, 510, 520, 530 may have any value, and each solid cellulose foam portion 110, 120, 210, 220, 230, 310, 320, 330, 410, 420, 430, 510, 520, 530 may for example be substantially longer than it is wide.

In one embodiment, as illustrated in FIG. 1d, a large number of identical solid cellulose foam portions 410, 420, 430 in cuboid shape are assembled to a solid cellulose foam object 400 in the shape of a plank. The width wₒ of the solid cellulose foam object 400 is equal to the sum of the widths of all the individual solid cellulose foam portions 410, 420, 430. The length lₒ and height hₒ of the solid cellulose foam object 400 is the same as the length of an individual solid cellulose foam portion 410, 420, 430. The length and width dimensions of such a cellulose foam plank 400 may be for example in the range of from 100 to 400 cm, such as at least 60 by 60 cm, or at least 100 by 100 cm, or at least 200 by 200 cm, or at least 300 by 300 cm. The height, i.e. thickness, of the foam plank may be in the range of from 1 to 20 cm, preferably from 1 to 10 cm, more preferably from 4 to 6 cm. The assembled plank may subsequently be cut into smaller foam articles of any size and shape.

When instead preparing a solid cellulose foam plank of such dimensions from a single deposition of wet cellulose foam, non-uniform shrinkage can be expected such that the thickness of the obtained solid foam plank varies along the length and/or width directions. By instead preparing a large number of solid cellulose foam portions 410, 420, 430 of smaller dimensions that are subsequently assembled to a foam plank 400, problems with non-uniform shrinkage are avoided and a plank 400 with no variations in thickness is obtained. Since the solid cellulose foam portions 410, 420, 430 are all in cuboid shape having a width that is similar to the height, non-uniform shrinkage during drying of the wet cellulose foam used to form the solid cellulose foam portions 410, 420, 430 can largely be avoided. This is due to the high ratio of surface area to height, which distributes tension during drying. Therefore, the present invention provides an improved solid cellulose foam plank 400 that is dimensionally stable. The thickness (i.e. height) of the foam plank 400 is uniform with no variations along the length and width directions.

As realized by a person skilled in the art, the size of the solid cellulose foam object 400 can be tailored by selection of the length of the solid cellulose foam portions 410, 420, 430 as well as the total number of additional solid cellulose foam portions 430 used to assemble the solid cellulose foam object 400.

The drying time of a small portion of wet cellulose foam is faster than the drying time of a large object of wet cellulose foam. Thus, the total drying time for drying an object of a certain size is reduced by preparing smaller cellulose foam portions 410, 420, 430 that are dried individually but simultaneously, and subsequently assembled to said object, compared to preparing and drying the said object directly in one piece.

The solid cellulose foam object 400 comprises in total eight solid cellulose foam portions 410, 420, 430. The solid cellulose foam object 400 thus comprises in total seven internal interfaces which means that the stiffness of the solid cellulose foam object 400 will increase compared to a solid cellulose foam object formed in one piece. This will improve the mechanical properties of the solid cellulose foam object 400 further.

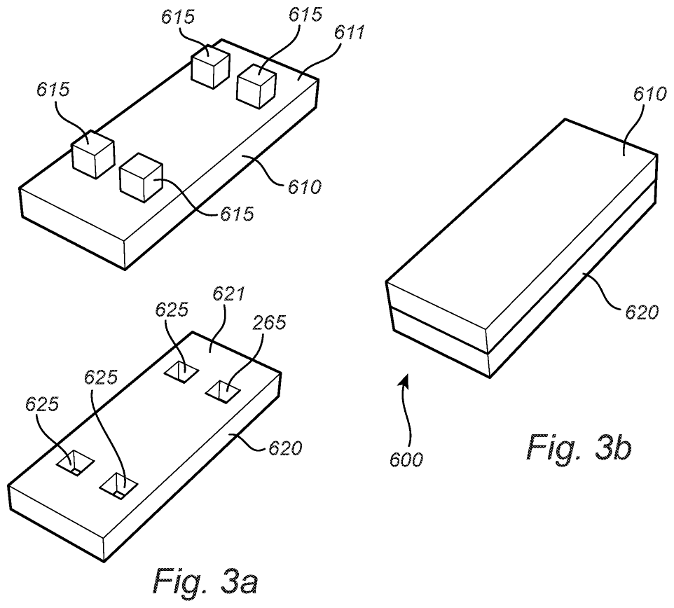

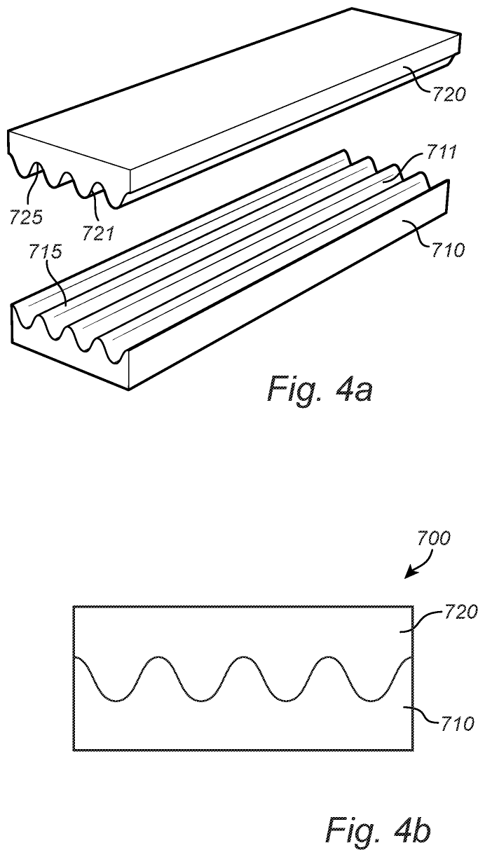

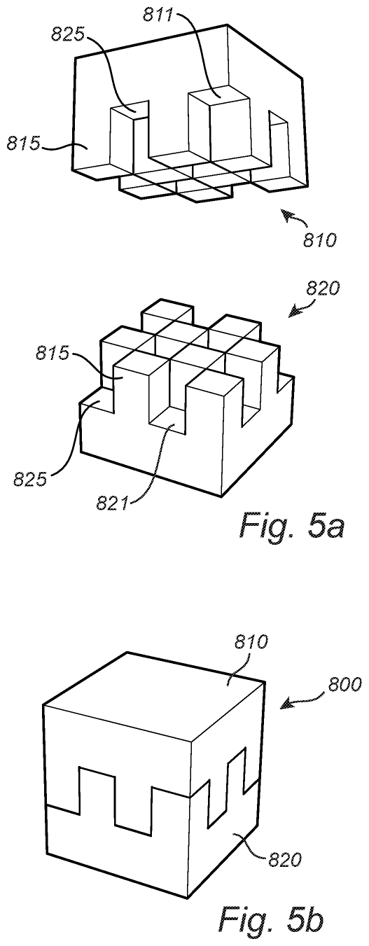

In an alternative embodiment of the present invention, as discussed in relation to FIG. 3a-b, FIG. 4a-b and FIG. 5a-b, the first connecting surface 611, 711, 811 of the first solid cellulose foam portion 610, 710, 810 comprises at least one protruding portion 615, 715, 815 and the first connecting surface 621, 721, 821 of the second solid cellulose foam portion 620, 720, 820 comprises at least one recess 625, 725, 825 and wherein the at least one recess 625, 725, 825 is configured to house the protruding portion 615, 715, 815. The first connecting surface 611, 711, 811 of the first solid cellulose foam portion 610, 710, 810 and the first connecting surface 621, 721, 821 of the second solid cellulose foam portion 620, 720, 820 are thus complimentary to each other. By providing the connecting surfaces 611, 621, 711, 721, 811, 821 to have complimentary shapes comprising protruding portions 615, 715, 815 and recesses 625, 725, 825, a stronger attachment may be obtained. The shapes of the connecting surfaces 611, 621, 711, 721, 811, 821 of the solid cellulose foam portions 610, 620, 710, 720, 810, 820 are selected such that non-uniform shrinkage of the wet cellulose foam during drying of the wet foam portions is minimized. After assembly of the solid cellulose foam object 600, 700, 800 there are no internal voids. This means that the recesses 625, 725, 825 are configured to have a size and shape that exactly matches that of the protruding portions 615, 715, 815.

An interface is formed when attaching the first connecting surfaces 611, 621, 711, 721, 811, 821 of the first and second solid cellulose foam portions 610, 620, 710, 720, 810, 820 providing stiffness to the assembled solid cellulose foam object 600, 700, 800 and thus improved mechanical properties. Depending on the shape, size and number of protruding portions 615, 715, 815 and recesses 625, 725, 825 the mechanical properties may be fine-tuned. Preferably, a densified layer is present on the first connecting surfaces 611, 621, 711, 721, 811, 821, further improving the mechanical properties.

The protruding portions 615, 715, 815 on the first connecting surface 611, 711, 811 of the first solid cellulose foam portion 610, 710, 810 may have any suitable size and shape. For example, the protruding portions 615, 715, 815 and the corresponding recesses 625, 725, 825 may have a cuboid shape, a triangular shape or a cylindrical shape. Preferably, the recesses 625, 725, 825 do not extend through the entire height of the second cellulose foam portion 620, 720, 820. In other words, the height of the protruding portion(s) 615, 715, 815 is preferably smaller than the height of the second solid cellulose portion 620, 720, 820. Thus, once the solid cellulose foam object 600, 700, 800 is assembled, the recesses 625, 725, 825 and protruding portions 615, 715, 815 are not visible on the top and bottom surfaces of the solid cellulose foam object 600, 700, 800. To minimize non-uniform shrinkage during drying, it is preferable that the width of each protruding portion 615, 715, 815 is similar to its height. For example, the width of each protruding portion 615, 715, 815 may be in the range of from 0.8 to 1.2, such as 0.9 to 1.1, or 0.95 to 1.05, times its height. The width is measured at the widest point of the protruding portion 615, 715, 815, and the height is measured at the highest point.

In embodiments where more than one protruding portion 615, 715, 815 is present, the size and shape of all protruding portions 615, 715, 815 may be the same, or may be different at different parts of the first solid cellulose foam portion 610, 710, 810. Preferably, each protruding portion 615, 715, 815 has the same size and shape, since manufacturing in that case is simplified.

The number of protruding portions 615, 715, 815 may vary depending on the size and shape of the protruding portion 615, 715, 815 and the size and shape of the first solid cellulose foam portion 610, 710, 810.

The protruding portions 615, 815 may be in the shape of individual units having a length similar in dimension to the height and width, regularly placed over the first connecting surface 611, 811 of the first solid cellulose portion 610, 810 (as illustrated in FIG. 3a-b and FIG. 5a-b). Such protruding portions 615, 815 may be of cuboid shape, of pyramid shape, of cylinder shape or of any other suitable shape. In the embodiment illustrated in FIG. 3a, the four protruding portions 615 of the first connecting surface 611 are all in the shape of cuboid pillars, of the same size. The corresponding recesses 625 are thus in the shape of cuboid recesses.

In some embodiments of the present invention, as illustrated in FIGS. 4a and 5a, the first connecting surfaces 711, 721, 811, 821 of the first solid cellulose foam object 710, 810 and the second solid cellulose foam object 720, 820 comprises at least one protruding portion 715, 815 and at least one recess 725, 825. In such embodiments, the surface area of the foam portion is increased and consequently the drying time is decreased.

In one embodiment, as illustrated in FIG. 4a-b, each protruding portion 715 and each recess 725 extend along the entire length of the first solid cellulose foam portion 710 and second solid cellulose foam portion 720 respectively. Alternatively, each protruding portion and each recess may extend along the entire width of the first solid cellulose foam portion and second solid cellulose foam portion respectively. In the embodiment illustrated in FIG. 4a, the first connecting surfaces of the first and second solid cellulose foam portions 710, 720 comprise both protruding portions 715, and recesses 725, extending along the length of the first and second solid cellulose foam portions. A cross section of the first and second solid cellulose foam portions taken perpendicular against the length direction of the extending protruding portions and recesses, shows that the first and second connecting surfaces have the form of a sine wave. The first solid cellulose foam portion 710 is complementary to that of the second solid cellulose foam portion 720. Once assembled, there will be no gaps between the first and second solid cellulose foam portions 710, 720, as illustrated in FIG. 4b, showing a side-view of the assembled solid cellulose foam object 700. Advantages with the embodiment illustrated in FIG. 4a and FIG. 4b is that the surface area increases due to the sine form of protruding portions 715 and recesses 725 in the first and second connecting surfaces 711, 721, which in turn will lead to a decrease in drying time. Non-uniform shrinkage during drying will also be minimized due to distribution of tension forces within the connecting surfaces having the form of a sine wave.

In embodiments where the first and second connecting surfaces 711, 721 comprises at least one protruding portion 715 and at least one recess 725 that extend along the length or width of the first and second solid cellulose foam portions 710, 720, the first and second connecting surfaces 711, 721 may have a waveform, when viewed in a cross section of the first and second solid cellulose foam portion 710, 720 taken perpendicular against the direction of the extending protruding portions 715 and recesses 725. The waveform is preferably periodic and may be selected from a sine wave (as illustrated in FIG. 4a-b), a square wave, a sawtooth wave, or a triangle wave.

In one embodiment, as illustrated in FIG. 5a, connecting surfaces 811, 821 of a first solid cellulose foam portion 810 and a second solid cellulose foam portion 820 comprise regularly spaced protruding portions 815 in the shape of cuboid pillars, and recesses 825. The connecting surfaces 811, 821 are complimentary to each other such that there are no gaps between the first solid cellulose foam portion 810 and second solid cellulose foam portion 820 once assembled into a solid cellulose foam object 800, as shown in FIG. 5b. Such embodiments may be preferred since non-uniform shrinkage during drying of the wet foam shapes is minimized due to the distribution of tension forces.

In embodiments of the present invention where the first connecting surfaces 611, 711, 811 of the first and second solid cellulose foam portions 610, 620, 710, 720, 810, 820 are provided with protruding portions 615, 715, 815 and recesses 625, 725, 825 respectively, the other surfaces of the first and second solid cellulose foam portions 610, 620, 710, 720, 810, 820 are preferably flat. In such embodiments, the solid cellulose foam object 600, 700, 800 preferably comprises only the first and second solid cellulose foam portions 610, 620, 710, 720, 810, 820, and no additional solid cellulose foam portions. The length and width of the first and second solid cellulose foam portions 610, 620, 710, 720, 810, 820 thus corresponds to those of the solid cellulose foam object 600, 700, 800 after assembly. Optionally, additional solid cellulose foam portions may be attached to second connecting surfaces of the first and/or second solid cellulose foam portions 610, 620, 710, 720, 810, 820. Alternatively, a second connecting surface of the first and/or second cellulose foam portions 610, 620, 710, 720, 810, 820 may also be provided with protruding portions and/or recesses and be attached to the first connecting surface of an additional solid cellulose foam portion, the connecting surface of which has been provided with protruding portion and/or recesses configured to correspond to those of the connecting surface it is to be attached to.

According to a second aspect, the present invention relates to a method for producing a solid cellulose foam object 100, 200, 300, 400, 500, 600, 700, 800 comprising at least two individual solid cellulose foam portions. The method according to the second aspect can be used to produce the solid cellulose foam object 100, 200, 300, 400, 500, 600, 700, 800 according to the first aspect.

The method according to the second aspect comprises the steps of:
providing at least one wet cellulose foam;
shaping and drying the wet cellulose foam, so as to obtain a first solid cellulose foam portion 110, 210, 310, 410, 510, 610, 710, 810; a second solid cellulose foam portion 120, 220, 320, 420, 520, 620, 720, 820; and optionally at least one additional solid cellulose foam portion 230, 330, 430, 530; wherein the first solid cellulose foam portion 110, 210, 310, 410, 510, 610, 710, 810 comprises a first connecting surface 511, 611, 711, 811 and optionally a second connecting surface 512; wherein the second solid cellulose foam portion 120, 220, 320, 420, 520, 620, 720, 820 comprises a first connecting surface 521, 621, 721, 821 and optionally a second connecting surface 522; and wherein the optional at least one additional solid cellulose foam portion 230, 330, 430, 530 comprises a first connecting surface 531 and optionally a second connecting surface 532;
attaching the first connecting surface 511, 611, 711, 811 of the first solid cellulose foam portion 110, 210, 310, 410, 510, 610, 710, 810 and the first connecting surface 521, 621, 721, 821 of the second cellulose foam portion 120, 220, 320, 420, 520, 620, 720, 820 so as to obtain a solid cellulose foam object 100, 200, 300, 400, 500, 600, 700, 800; and
optionally attaching the first connecting surface 531 of the at least one additional cellulose foam portion 230, 330, 430, 530 to the second connecting surface 512, 522 of the first solid cellulose foam portion and/or the second solid cellulose foam portion 220, 320, 420, 520.

In the first step of the method according to the second aspect, at least one wet cellulose foam is provided, the details of which are further described above. Preferably, the same wet cellulose foam is used to prepare all solid cellulose foam portions used for assembly of the solid cellulose foam object. Alternatively, more than one wet cellulose foam may be provided, the properties of the wet foams being different, such as in terms of composition or density.

In the next step of the method according to the second aspect, the wet cellulose foam is shaped and dried to obtain solid cellulose foam portions of a desired shape. Shaping can be carried out using any suitable means. For example, shaping can be carried out using a mould, by forming a deposited wet foam using e.g. a scraper, or by depositing the wet foam in a desired shape by e.g. extrusion. When precise shapes are required, e.g. when shaping complex connecting surfaces comprising several protruding portions and recesses (such as illustrated in FIG. 5a-b), it is often advantageous to perform shaping using a mould. Shaping is preferably performed on the wet cellulose foam, prior to drying. In an alternative embodiment, the wet cellulose foam is dried in large sheets which can subsequently be shaped by cutting into the desired shape. This is however not preferred since material will be wasted during the cutting.

In some embodiments, moulds are used to shape the wet cellulose foams. The wet cellulose foam may be placed in a mould having a shape corresponding to the desired shape of the solid cellulose foam portion to be formed. The mould may also be in the form of a frame placed on a surface. The mould may have only an open top, or may have several open sides, depending on the shape to be obtained. The mould may also be in the form of a shaped belt. The mould may be removed prior to drying, or it can remain during drying. Since the wet cellulose foam of the present invention is free-standing, it will retain its shape during drying also when the mould is removed prior to drying. In embodiments where the wet cellulose foam remains in the mould during drying, the mould is preferably perforated so that water can be evaporated through the mould during drying. Advantages of using a mould for shaping involve shape fidelity and heat transfer. When the mould remains during drying of the wet cellulose foam, shape precision is improved further since shrinkage is minimized.

In one embodiment, shaping is carried out by depositing the wet cellulose foam composition directly into the desired shape. This can be carried out by e.g. extrusion using suitable dispensing means, such as using 3D-printing. Since the wet cellulose foam composition is free-standing, the shape of the wet cellulose foam will remain during drying. The possibility to deposit the wet cellulose foam as a free-standing wet foam enables a great versatility in the shapes that can be created.

In one embodiment, shaping is carried out by scraping the surfaces of the first wet foam and the second wet foam after deposition of the wet foam on a surface. The surfaces are shaped to the desired shape prior to drying of the wet foams. Scraping can be performed using any suitable means, such as a scraper, blade or roller. Such methods of shaping are easy to perform also at a larger scale.

Shaping may be carried out in several steps, such as by first depositing a wet foam on a surface, followed by subsequent depositions of wet foams to obtain what is to become the protruding portions after drying. In embodiments where the solid cellulose foam portions have different sizes or shapes, different methods of shaping may be employed so that the desired shape is obtained.

Shaping is carried out such that the dimensions of the obtained wet cellulose foam portions are optimal in terms of minimizing non-uniform shrinkage during subsequent drying, as well as to obtain a short drying time. This may involve for example shaping wet cellulose foam portions having a height that is similar to the width. For embodiments where the connecting surfaces comprise protruding portions and/or recesses, the surface area of the foam portions is increased which is beneficial for shortening the drying time. By forming protruding portions and/or recesses with at least two dimensions selected from length, width or height being similar, non-uniform shrinkage during drying can be minimized.

In embodiments where solid cellulose foam portions of cuboid shape are used, as illustrated in FIG. 1a-d and FIG. 2, wet cellulose foam may be shaped using a frame placed on a perforated tray. Wet cellulose foam is deposited inside the frame and the top is scraped to obtain a smooth surface. Preferably, the frame remains during drying of the wet cellulose foam to ensure that shrinkage is minimized and that solid cellulose foam portions 110, 120, 210, 220, 230, 310, 320, 330, 410, 420, 430, 510, 520, 530 having precise dimensions are obtained.

In embodiments where the first connecting surface 611 of the first solid cellulose foam portion 610 comprises at least one protruding portion 615 in the shape of a pillar, as illustrated in FIG. 3a, the protruding portions 615 may be shaped for example by depositing wet cellulose foam on top of a wet cellulose foam sheet deposited on a supporting surface. The corresponding recesses 625 on the first connecting surface 621 of the second cellulose foam portion 620 may be shaped using a mould. Alternatively, also the protruding portions 615 may be shaped using a mould.

In embodiments where the protruding portions 715 and/or recesses 725 are extending along the length and/or width of the first and/or second solid cellulose foam portion 710, 720, as illustrated in FIG. 4a, the wet cellulose foam may be shaped by a mould having a corresponding shape, such as by depositing the foam on a shaped belt and flattening the top surface of the deposited foam. Depositing the wet foam on a shaped belt will facilitate upscaling of the process. For example, in embodiments where the connecting surfaces 711, 721 has a waveform, continuous large-scale production may involve depositing a wet foam on a shaped belt with protruding portions and recesses extending in a width direction, and levelling the top surface of the wet foam. Alternatively, shaping may be performed by first depositing a wet cellulose sheet on a supporting surface, and subsequently shaping the top surface of the wet sheet using a scraper or a roller. This way of shaping also facilitates upscaling of the process. For example, in embodiments where the connecting surfaces 711, 721 has a waveform, continuous production may involve depositing a sheet of wet foam on a belt, and then forming the top surface of the wet foam sheet by means of a roller or scraper so that protruding portions and recesses are formed along the length of the foam.

In embodiments where the first connecting surfaces 711, 721 of the first and second solid cellulose foam portions 710, 720 both comprise a number of protruding portions 715 and recesses 725 extending along the entire width or length of the solid cellulose foam portions 710, 720, as illustrated in FIG. 4a, the first and second solid cellulose foam portions 710, 720 may be joined during manufacturing. In such embodiments, the wet cellulose foam is shaped, for example by deposition on a shaped belt, or by using a roller, as a single large portion. Preferably, the shaping is performed such that the top or bottom surface of the wet cellulose foam has a waveform. The shaped surface will become a connecting surface 711, 721 in the dried solid cellulose foam portion 710, 720. After drying, the large foam portion is divided, such as by cutting, to obtain the first and second cellulose foam portions 710, 720, preferably being of equal size. The connecting surfaces 711, 721 of the cellulose foam portions 710, 720 are complimentary to each other. Manufacturing is simplified by such a process, since shaping and drying is performed only on one wet foam deposition instead of on two depositions.

In embodiments where the first connecting surfaces 811, 821 of the first and second solid cellulose foam portions 810, 820 comprises several protruding portions 815 and recesses 825 forming a complex shape, such as illustrated in FIG. 5a, shaping may preferably be performed by means of a mould corresponding to the desired shape in order to ensure that correct dimensions are maintained.

Drying of the shaped wet cellulose foam portions may be carried out by evaporation at room temperature or at an elevated temperature, such as a temperature of from 40° C. to 140° C. Any suitable equipment may be used. After drying, solid cellulose foam portions of a shape corresponding to the shaped wet cellulose foam portions are obtained. If a mould is used for shaping, the cellulose foam may remain in the mould during drying, or the mould may be removed prior to drying. As described above, densified layers are formed on the outer surfaces of the cellulose foam during drying.

As previously discussed, the wet cellulose foam portions are shaped such that dimensions that are optimal for minimizing non-uniform shrinking during drying of the wet cellulose foam is obtained.

In embodiments where the first connecting surfaces 611, 621, 711, 721, 811, 821 of the solid cellulose foam portions 610, 620, 710, 720, 810, 820 comprises protruding portions 615, 715, 815 and/or recesses 615, 725, 825, such design distributes the tension build-up during drying of the foam so that capillary pressure and thus non-uniform shrinkage is minimized. In embodiments where all connecting surfaces of the solid cellulose foam portions are flat, non-uniform shrinkage during drying of the wet cellulose foam portions can be minimized by the width of a wet cellulose foam portions being similar to its height.

Optionally, the solid cellulose foam portions may be cut after drying and prior to assembly of the solid cellulose foam object. For example, in embodiments where the size of the solid cellulose foam portions 210, 220, 230 is different, such as illustrated in FIG. 1b, the solid cellulose foam portions 210, 220, 230 may be cut to obtain the desired length. In large scale production, rods of solid foam may be continuously produced and subsequently cut to obtain solid cellulose foam portions of a suitable length to assemble the structures according to the embodiments illustrated in FIGS. 1 and 2.

After drying, the first connecting surface 511, 611, 711, 811 of the first solid cellulose foam portion 110, 210, 310, 410, 510, 610, 710, 810 is attached to the first connecting surface 521, 621, 721, 821 of the second solid cellulose foam portion 120, 220, 320, 420, 520, 620, 720, 820 so as to obtain the solid cellulose foam object 100, 200, 300, 400, 500, 600, 700, 800. Optionally, at least one additional solid cellulose foam portion 230, 330, 430, 530 may be attached to the first and/or second solid cellulose foam portions. In preferred embodiments, the attachment occurs along the entire connecting surfaces. In other embodiments, attachment occurs along parts of the connecting surfaces. The connecting surface is preferably present along the entire length of the solid cellulose foam portion.

The step of attaching involves putting the first connecting surface 511, 611, 711, 811 of the first solid cellulose foam portion 110, 210, 310, 410, 510, 610, 710, 810 and the first connecting surface 521, 621, 721, 821 of the second solid cellulose foam portion 120, 220, 320, 420, 520, 620, 720, 820 in contact with each other. Attachment means, such as an adhesive, may be situated in between the first solid cellulose foam portion 110, 210, 310, 410, 510, 610, 710, 810 and second solid cellulose foam portion 120, 220, 320, 420, 520, 620, 720, 820. Any additional solid cellulose foam portions 230, 330, 430, 530 may be attached in a similar fashion.

In some embodiments, pressure may be applied during the attachment step. By applying pressure during the step of attachment, it is ensured that the first solid cellulose foam portion 110, 210, 310, 410, 510, 610, 710, 810 and the second solid cellulose foam portion 120, 220, 320, 420, 520, 620, 720, 820 come into close contact with each other so as to ensure a strong attachment. Pressure may be applied using any suitable pressing means. For example, pressing means such as rollers, bars or plates may be used. Pressure may be applied to one of the solid cellulose foam portions that are to be attached, or to some, or to all. In embodiments where additional solid cellulose foam portions are to be attached, pressure may be applied after attachment of each additional solid cellulose foam portion 230, 330, 430, 530, or may be applied once all additional solid cellulose foam portions 230, 330, 430, 530 have been attached.

The attachment step typically involves manually or automatically placing one solid cellulose foam portion in close contact with another solid cellulose foam portion. Any suitable equipment as known by a person skilled in the art can be used. For example, the first solid cellulose foam portion 110, 210, 310, 410, 510, 610, 710, 810 may be placed with the first connecting surface 511, 611, 711, 811 facing upwards. An adhesive may then be applied to the first connecting surface 511, 611, 711, 811, before positioning the first connecting surface 521, 621, 721, 821 of the second solid cellulose foam portion 120, 220, 320, 420, 520, 620, 720, 820 on the first connecting surface 511, 611, 711, 811 of the first solid cellulose foam portion 110, 210, 310, 410, 510, 610, 710, 810. Pressure may then be applied, for example by means of passing the assembled solid cellulose foam object underneath a roller applying pressure.

The step of attaching may involve any suitable attachment means. In some embodiments, the step of attaching involves applying an adhesive to at least one connecting surface prior to attaching the first solid cellulose foam portion 110, 210, 310, 410, 510, 610, 710, 810, the second solid cellulose foam portion 120, 220, 320, 420, 520, 620, 720, 820 and the optional at least one additional solid cellulose foam portion 230, 330, 430, 530. Curing of the adhesive may be performed at room temperature or at an elevated temperature, depending on the type of adhesive. Preferably curing is performed at room temperature.

Any suitable adhesive may be used in the present invention. In some embodiments, the adhesive is selected from a hot melt glue, a wood adhesive, a starch-based glue, carboxymethyl cellulose (CMC), polyvinyl acetate, ethylene vinyl acetates, casein, latex, polyurethane, dextrin and gums, such as guar and xanthan. The adhesive is preferably water-based and/or biobased.

The adhesive may be applied to the connecting surface of the solid cellulose foam portion using any suitable method used for coating such as roller coating, blade/knife coating, brushing, flexo roller and spray coating. In some embodiments the adhesive is applied to the first connecting surface 511, 611, 711, 811 of the first solid cellulose foam portion 110, 210, 310, 410, 510, 610, 710, 810 or to the first connecting surface 521, 621, 721, 821 of the second solid cellulose foam portion 120, 220, 320, 420, 520, 620, 720, 820. In some embodiments, the adhesive is applied to both the first connecting surface 511, 611, 711, 811 of the first solid cellulose foam portion 110, 210, 310, 410, 510, 610, 710, 810 and to the first connecting surface 521, 621, 721, 821 of the second solid cellulose foam portion 120, 220, 320, 420, 520, 620, 720, 820. When the adhesive is applied to both connecting surfaces, a stronger and more durable attachment will be obtained. Similarly, in embodiments where the solid cellulose foam object 100, 200, 300, 400, 500, 600, 700, 800 comprises at least one additional solid cellulose foam portion 230, 330, 430, 530, adhesive may be applied to the second connecting surface 512, 522 of the first and/or second solid cellulose portion 210, 220, 310, 320, 410, 420, 510, 520, and/or to the first connecting surface 531 of the at least one additional solid cellulose foam portion 530.

In some embodiments, the attachment means involves a double-sided adhesive tape. The tape is placed at a connecting surface of a solid cellulose foam portion.

In embodiments where the solid cellulose foam comprises CMC, the step of attaching may comprise applying water to a connecting surface. The water will partly dissolve the outer surface of the connecting surface of the solid cellulose foam portion and provide adhesive properties by exposing CMC. For example, the first connecting surface 521, 621, 721, 821 of the second solid cellulose foam portion 120, 220, 320, 420, 520, 620, 720, 820 may be attached to the partly dissolved first connecting surface 511, 611, 711, 811 of the first solid cellulose foam portion 120, 220, 320, 420, 520, 620, 720, 820.

In some embodiments, the step of attaching may involve applying a thin layer of wet cellulose foam. Using a thin layer of wet foam for attachment results in a solid cellulose foam object 100, 200, 300, 400, 500, 600, 700, 800 that only comprises cellulose foam and no other materials, such as adhesives.

In embodiments where additional solid cellulose foam portions 230, 330, 430, 530 are attached, the attachment means may be selected from the same ones as described above. The same attachment means may be used for attachment of all solid cellulose foam portions used to assemble a solid cellulose foam object 100, 200, 300, 400, 500, 600, 700, 800. Alternatively, different attachment means may be used for attachment of the solid cellulose foam portions within a solid cellulose foam object 100, 200, 300, 400, 500, 600, 700, 800.

In embodiments where the first connecting surfaces 611, 621, 711, 721, 811, 821 of the first and second solid cellulose portions 610, 620, 710, 720, 810, 820 comprise at least one protruding portion 615, 715, 815 and/or recess 625, 725, 825 that are complimentary to each other, attachment involves fitting the first and second solid cellulose foam portions 610, 620, 710, 720, 810, 820 together such that the recess(es) 625, 725, 825 house the protruding portion(s) 615, 715, 815. In some embodiments, such as illustrated in FIG. 5a and FIG. 5b, the first and second solid cellulose foam portions 810, 820 will be attached simply by fitting the protruding portions 815 into the recesses 825. To provide for a strong and durable attachment, and thus a more stable solid cellulose foam object 800, other attachment means, such as an adhesive, are however also required.

The assembled solid cellulose foam object 100, 200, 300, 400, 500, 600, 700, 800 of the present invention may be cut into smaller pieces of any preferred size.

In some embodiments, additional substrates are attached to the solid cellulose foam object 100, 200, 300, 400, 500, 600, 700, 800. Such substrates may improve the stability and mechanical properties of the solid cellulose foam object 100, 200, 300, 400, 500, 600, 700, 800, and also facilitate further handling and processing, such as converting operations. The substrates may for example be selected from paper or board.

In some embodiments, a coating may be applied to any surface of the solid cellulose foam object 100, 200, 300, 400, 500, 600, 700, 800, and/or to the solid cellulose foam portion(s). The coating is preferably applied in the form of a liquid coating composition, and one or several coating layers can be applied. The composition of the coating layers may be the same or different. The coating may comprise at least one particulate material, or at least one particulate material and at least one film-forming material. The particulate material may be selected from at least one of microfibrillated cellulose (MFC), cellulose fibres or mineral particles such as clay or calcium carbonate. MFC shall in the context of the present application mean a cellulose particle, fibre or fibril having a width or diameter of from 20 nm to 1000 nm. The film-forming material may be selected from at least one of carboxymethyl cellulose (CMC), cellulose ethers, starch, polyvinyl alcohol or synthetic latexes, such as acrylic or styrene-butadiene latexes. The coating may comprise at least one hydrophobic agent, for example selected from at least one of a wax, such as bee's wax or carnauba, alkyl ketene dimer (AKD) or alkyl succinic anhydride (ASA).

By application of a coating, the air permeability of the solid cellulose foam decreases since pores on the surface of the foam are closed by the coating. This facilitates various processing and converting operations involving vacuum. In addition, and depending on the type of coating, properties such as strength and hydrophobicity of the solid cellulose foam may be altered by application of a coating. The coating is preferably applied to a surface of the foam comprising a densified layer.

The coating composition may be applied using any suitable method used for coating such as roller coating, blade/knife coating, brushing, flexo roller, and spray coating.

### EXAMPLES

### Example 1—Preparation of Wet Cellulose Foam

Wet cellulose foams having a dry-content of 15.8% were prepared. The wet foam compositions all comprised 10 wt % CMC, 1 wt % surfactants and 89 wt % cellulose fibres, based on the total weight of the solid content of the wet foam composition. Cellulose fibres (125 g, softwood bleached Kraft pulp fibres) were disintegrated in 700 ml water using a Kenwood Chef XL Titanium mixer equipped with the K beater. CMC (13.5 g) was added as a dry powder after achieving adequate pulping of the cellulose fibre suspension and mixed with the K beater until reaching a homogenous mixture. Thereafter, a surfactant solution (20 wt %) containing 1:1 molar ratio of sodium cocoyl sarcosinate: myristic acid was added (8 ml) to the cellulose fibre/CMC solution mixture. The mixture was then aerated using the balloon whipper of Kenwood mixer until the desired amount of air was mechanically introduced to the mixture. After mixing, foam was collected in a 250 ml plastic cup and density was measured (target density was 188 kg/m³).

### Example 2—Preparation of Rod-Shaped Foam Portions

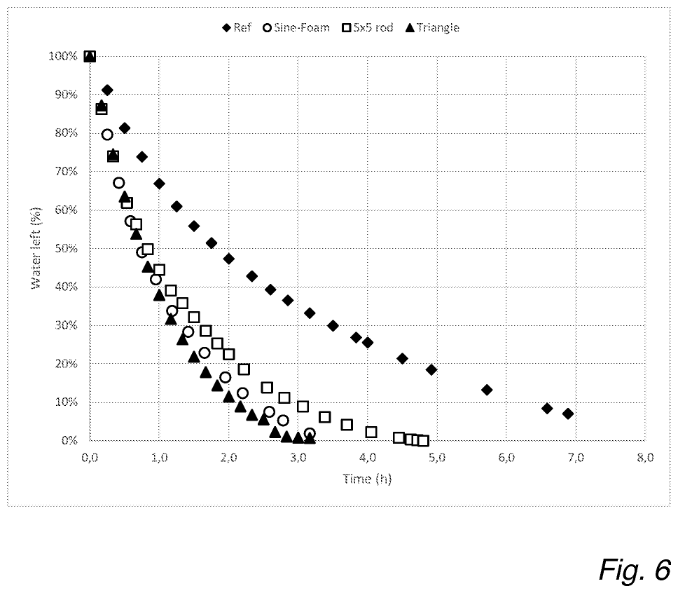

The wet cellulose foam of example 1 was shaped using two perforated metal sheets. The metal sheets had dimensions of 10 by 36 cm and were bent along the along the middle in the length direction to give two L-shaped trays, having a base of 5 cm, height of 5 cm and length of 36 cm. The two trays were filled with wet foam and put together to create a 5×5×36 cm perforated metal mould. The wet cellulose foam inside the mould was dried in a convection oven at 120° C., the foam remained inside the mould during drying. The foam was weighted at several points in time during drying. The obtained drying curve is shown in FIG. 6 (5×5 rod). The drying rate was improved compared to a foam having the same height and length but a larger width, since heating from all sides is more efficient and the ratio of surface area to volume is increased. After drying, a solid cellulose foam portion in the shape of a rod having dimension of 5×5×36 cm is obtained. No shrinkage was observed due to the wet foam being restricted by the mould during drying.

Several rods could be glued together to form a large cellulose foam plank.

### Example 3—Preparation of Sinusoidal Shaped Foam Portions

The wet cellulose foam of example 1 was deposited in a frame (24.5 by 44 cm by 5 cm) placed on a surface. A wooden scraper with a sine-wave shape was used to scrape the top surface of the deposited wet foam, to obtain a wet foam having a sine wave shape, with hills (protruding portions) and valleys (recesses). The height of a protruding portion was 4 cm, and the distance between adjacent peaks in the wave shape was 6 cm. The recesses did not extend all the way through the wet foam. Shaping was done either in the width direction or in the length direction. The shaped wet cellulose foam was dried in a convection oven at 120° C. The foam was weighted at several points in time during drying. The obtained drying curve is shown in FIG. 6 (sine-foam). The drying rate was improved compared to the reference foam of similar dimensions. The valleys will dry fast due to their small height, meaning that the hills will behave like individual units, each with a large surface area, during drying. Hence drying of the sine-shaped foam is fast. Since the ratio of surface area to volume is greater for the sine wave shape of example 3 than for the rods of example 2, drying is faster for the foam having a sine wave shape.

Some shrinkage was observed during drying, but the shrinkage was uniform and two sine-shaped foams could be glued together to create a cuboid foam article.

### Example 4—Preparation of Triangularly Shaped Foam Portions

The wet cellulose foam of example 1 was deposited in a frame placed on a surface. A perforated metal sheet was bent so that a triangle wave shape was obtained, with triangular shapes extending along the width of the metal sheet. The bent metal sheet, together with a wooden frame (24 by 30 by 5 cm), was used as a mould into which the wet cellulose foam was deposited. Thus, the bottom surface of the wet cellulose foam deposition was shaped. The top surface was scraped so as to obtain an even surface. The wet cellulose foam inside the mould was dried in a convection oven at 120° C., the foam remained inside the mould during drying. The foam was weighted at several points in time during drying. The obtained drying curve is shown in FIG. 6 (triangle). The drying rate was improved compared to the reference foam of similar dimensions. At the base of the triangular shapes, drying is quick due to the low thickness of the foam. Inside the triangular shapes, drying rates are improved due to the increase in surface area. The drying rate for the triangle wave shaped foam is similar to that of the sine wave shaped foam.

Since the wet foam remained inside the mould during drying, shape retention was good and no shrinkage was observed. Two triangularly shaped foam portions could be glued together to create a cuboid foam article.

### Example 5 (Comparative)—Preparation of a Foam Sheet

The wet cellulose foam of example 1 was deposited in a frame (24.5 by 44 cm) placed on a surface. The thickness of the foam was 5 cm. The wet cellulose foam inside the frame was dried in a convection oven at 120° C., the foam remained inside the frame during drying. The foam was weighted at several points in time during drying. The obtained drying curve is shown in FIG. 6 (ref). The drying time is significantly longer compared to the shapes in examples 3, 4 and 5, since the thickness is uniform and the ratio of surface area to volume is low compared to the other foams.

Non-uniform shrinkage in the height direction was observed, with the thickness being lower in the middle of the dried foam sheet than along the edges.

In view of the above detailed description of the present invention, other modifications and variations will become apparent to those skilled in the art. However, it should be apparent that such other modifications and variations may be effected without departing from the spirit and scope of the invention.

1. A solid cellulose foam object comprising:
a first solid cellulose foam portion comprising a first connecting surface and optionally a second connecting surface; and
a second solid cellulose foam portion comprising a first connecting surface and optionally a second connecting surface;
wherein the first connecting surface of the first solid cellulose foam portion and the first connecting surface of the second solid cellulose foam portion are attached to each other so as to form the solid cellulose foam object; and
wherein the solid cellulose foam object optionally comprises at least one additional solid cellulose foam portion comprising a first connecting surface and optionally a second connecting surface, and wherein the first connecting surface of the at least one additional solid cellulose foam portion is attached to the second connecting surface of the first solid cellulose foam portion or the second solid cellulose foam portion, or both.

2. The solid cellulose foam object according to claim 1, wherein the solid cellulose foam object is essentially rigid.

3. The solid cellulose foam object according to claim 1, wherein a density of the solid cellulose foam object is in a range of from 10 to 80 kg/m³.

4. The solid cellulose foam object according to claim 1, wherein the first solid cellulose foam portion, the second solid cellulose foam portion and, optionally, the at least one additional solid cellulose foam portion comprise cellulose fibres in a range of from 71 to 95wt % based on a total dry weight of the solid cellulose foam object.

5. The solid cellulose foam object according to claim 1, wherein the first solid cellulose foam portion, the second solid cellulose foam portion and, optionally, the at least one additional solid cellulose foam portion all comprise:
cellulose fibres in a range of from 71 to 95 wt % based on a total dry weight of the solid cellulose foam object,
a water-soluble thickener in a range of from 4 to 24 wt % based on the total dry weight of the solid cellulose foam object, and
at least two surfactants.

6. The solid cellulose foam object according to claim 1, wherein the solid cellulose foam object is in a shape of a cuboid having a length lₒ, a width wₒ and a height hₒ.

7. The solid cellulose foam object according to claim 1, wherein the first solid cellulose foam portion is in a shape of a cuboid having a length lₗ, a width wₗ and a height hₗ,
wherein the second solid cellulose foam portion is in a shape of a cuboid having a length l₂, a width w₂ and a height h₂,
wherein, optionally, the at least one additional solid cellulose foam portion is in a shape of a cuboid having a length lₐ, a width wₐ and a height hₐ, and,
optionally, wherein dimensions of the first solid cellulose foam portion, the second solid cellulose foam portion and, if present, the at least one additional solid cellulose foam portion are the same.

8. The solid cellulose foam object according to claim 7, wherein the first connecting surfaces and the second connecting surfaces are situated along the length of the first solid cellulose foam portion, the length of the second solid cellulose foam portion and the length of the at least one additional solid cellulose foam portion respectively.

9. The solid cellulose foam object according to claim 1, wherein the first connecting surface of the first solid cellulose foam portion comprises at least one protruding portion and the first connecting surface of the second solid cellulose foam portion comprises at least one recess, and wherein the at least one recess is configured to house the at least one protruding portion.

10. The solid cellulose foam object according to claim 9, wherein the first connecting surfaces of the first solid cellulose foam portion and the second solid cellulose foam portion both comprises at least one protruding portion and at least one recess.

11. The solid cellulose foam object according to claim 9, wherein each protruding portion and each recess extends in a direction along the width or length of the first solid cellulose portion and the second solid cellulose portion respectively.

12. The solid cellulose foam object according to claim 11, wherein, in a cross section of the first and second solid cellulose foam portions taken perpendicular against the direction, the first and second connecting surfaces have a waveform.

13. The solid cellulose foam object according to claim 12, wherein the waveform is selected from a group consisting of: a sine wave, a square wave, a sawtooth wave, and a triangle wave.

14. A method for producing a solid cellulose foam object, wherein the method comprises the steps of:
providing at least one wet cellulose foam;
shaping and drying the at least one wet cellulose foam, so as to obtain a first solid cellulose foam portion, a second solid cellulose foam portion, and, optionally, at least one additional solid cellulose foam portion, wherein the first solid cellulose foam portion comprises a first connecting surface and optionally a second connecting surface, wherein the second solid cellulose foam portion comprises a first connecting surface and optionally a second connecting surface, and wherein the at least one additional solid cellulose foam portion comprises a first connecting surface and optionally a second connecting surface;
attaching the first connecting surface of the first solid cellulose foam portion to the first connecting surface of the second cellulose foam portion so as to obtain a solid cellulose foam object; and
optionally, attaching the first connecting surface of the at least one additional cellulose foam portion to the second connecting surface of the first solid cellulose foam portion, or the second solid cellulose foam portion, or both.

15. The method according to claim 14, wherein the at least one wet cellulose foam comprises; between 10-38 wt % cellulose fibres, 0.5-10 wt % of water-soluble thickener, and 0.1-2 wt % surfactants, as calculated on a total weight of the at least one wet cellulose foam.

16. The method according to claim 15, wherein the at least one wet cellulose foam has a density of from 120-500 kg/m³ and a yield stress of at least 80 Pa.

17. The method according to claim 14, wherein shaping is performed such that the first solid cellulose foam portion, the second solid cellulose foam portion. and, if present, the at least one additional solid cellulose foam portion are all of cuboid shape.

18. The method according to claim 14, wherein shaping is performed such that the first connecting surface of the first solid cellulose foam portion comprises at least one protruding portion and the first connecting surface of the second solid cellulose foam portion comprises at least one recess configured to house the at least one protruding portion.

19. The method according to claim 18, wherein shaping is performed such that the first connecting surfaces of the first solid cellulose foam portion and the second solid cellulose foam portion both comprises at least one protruding portion and at least one recess.

20. The method according to claim 18, wherein shaping is performed such that each protruding portion and each recess extends in a direction along a length or a width of the first solid cellulose foam portion and the second solid cellulose foam portion.

21. The method according to claim 20, wherein, in a cross section of the first and second solid cellulose foam portions taken perpendicular against the direction, the first and second connecting surfaces are shaped with a waveform.

22. The method according to claim 21, wherein the waveform is selected from a group consisting of: a sine wave, a square wave, a sawtooth wave, and a triangle wave.

23. The method according to claim 18, wherein the attaching comprises placing the at least one protruding portion of the first connecting surface of the first solid cellulose foam portion into the at least one recess of the first connecting surface of the second solid cellulose portion.

24. The method according to claim 14, wherein the attaching comprises applying an adhesive to at least one connecting surface prior to attaching the first solid cellulose foam portion, the second solid cellulose foam portion, and, if present, the at least one additional solid cellulose foam portion.

25. (canceled)
